(19) United States
(12) Patent Application Publication
(10) Pub. No.: US 2020/0368568 A1
(43) Pub. Date: Nov. 26, 2020

(54) ELECTRIC HEATER FIRE EXTINGUISHING STRATEGY CUSTOMIZATION MECHANISM

(71) Applicant: Gaoli Ge, Zhejiang (CN)

(72) Inventor: Gaoli Ge, Zhejiang (CN)

(21) Appl. No.: 16/966,312

(22) PCT Filed: Apr. 12, 2019
(86) PCT No.: PCT/CN2019/082532

§ 371 Date: Jul. 30, 2020

(30) Foreign Application Priority Data
Jun. 4, 2018 (CN) 201810564207.X

(51) Int. Cl. A62C 37/36; G06T 5/00; G06T 7/11; G06T 7/136; G06T 7/13; G06T 7/73; F24C 7/08

(52) U.S. Cl. CPC A62C 37/04; G06T 5/003; G06T 7/11; G06T 7/136; G06T 2207/20208; G06T 5/009; G06T 7/73; F24C 7/081; G06T 2207/20192; G06T 7/13

(57) ABSTRACT

An electric heater fire extinguishing strategy customization mechanism includes: a timing device for outputting the current operation time; a real-time display device installed onto an integrated circuit board of the electric heater and connected to the timing device for receiving the current operation time and displaying a red string corresponding to the real-time display and too-long operation information of when the current operation time exceeds a limit; a position sensing device installed onto the dot-matrix imaging mechanism for detecting the current position of the dot-matrix imaging mechanism, determining the difference between the current position and a predetermined fixed position, wherein the difference includes a horizontal change and a vertical change, and issuing a jitter sensing signal when the horizontal change changes between positive and negative values or the vertical change changes between positive and negative values. The electric heater includes a fire extinguishing function.

### FIELD OF THE INVENTION

The present invention relates to the technical field of household equipment, and more particularly to an electric heater fire extinguishing strategy customization mechanism.

### BACKGROUND OF THE INVENTION

Electric heater can be divided according to its appearance into oil-filled heater, hot-air heater and thermal radiator. The oil-filled heater is a common commercially available electric heater and has an external shape similar to the household radiator; the hot-air heater is generally divided into a bathroom hot-air heater and a non-bathroom hot-air heater, wherein the bathroom hot-air heater has the features of small size, strong wind power, fast warming, and fully enclosed design and the capability of ensuring the safety of use; the non-bathroom hot-air heater has an external shape similar to a wall heater; and the thermal radiator has an external shape similar to an electric fan except that the vane and post guard are substituted by the electric heating component and arc reflector respectively.

### SUMMARY OF THE INVENTION

In view of the aforementioned drawbacks and deficiencies of the conventional electric heater that may cause fire easily, it is a primary objective of the present invention to provide an electric heater fire extinguishing strategy customization mechanism installed on an electric heater for determining a spraying position of an automatic fire extinguishing operation based on the positioning data of a flame target, and determining a spraying strength of the automatic fire extinguishing operation based on the positioning data of the flame target, wherein a position sensing device is provided for determining the jitter condition of a dot-matrix imaging mechanism, and then accurately determining the direction and amount of jitter of the dot-matrix imaging mechanism based on the pixel value search results of the previous and next images after the jitter is determined; enhancing the contrast of images in different areas for the distribution of edge points in the images to facilitate various subsequent image processes; performing a self-adjusting filter processing of the filter processing of the edge-enhanced images for the dense noise distribution area only to achieve a balance between the filtering effect and the filtering computation, while obtaining an area to be identified effectively from a customized background segmentation mode.

To achieve the aforementioned and other objectives, the present invention discloses an electric heater fire extinguishing strategy customization mechanism, comprising: a timing device, installed onto an integrated circuit board of the electric heater, for counting and using the elapsed time of the electric heater as a current operation time, and outputting the current operation time; and a real-time display device, installed onto the integrated circuit board of the electric heater, and coupled to the timing device, for receiving the current operation time, and being used for a real-time display and a red string corresponding to a too-long operation when the current operation time exceeds a limit.

Specifically, the electric heater fire extinguishing strategy customization mechanism further comprises a position sensing device installed on the dot-matrix imaging mechanism for detecting the current position of the dot-matrix imaging mechanism and determining the difference between the current position and a predetermined fixed position, wherein the difference includes a horizontal change and a vertical change, and if the horizontal change changes between positive and negative values or the vertical change changes between positive and negative values, then a jitter sensing signal will be sent, or else a non-jitter sensing signal will be sent; and a dot-matrix imaging mechanism for photographing the surrounding of the electric heater and continuously outputting a plurality of electric heater surrounding images by a predetermined frame rate.

Specifically, the electric heater fire extinguishing strategy customization mechanism further comprises an image data extraction device coupled to the dot-matrix imaging mechanism for receiving and using two images sequentially obtained by the dot-matrix imaging mechanism as a current image and a subsequent image respectively, and obtaining a pixel value of each pixel point of the current image and a pixel value of each pixel point of the subsequent image.

Specifically, the electric heater fire extinguishing strategy customization mechanism further comprises: a pixel point searching device coupled to the image data extraction device and the position sensing device for entering into a jitter detection mode when the jitter sensing signal is received, and exiting the jitter detection mode when the non-jitter sensing signal is received; the pixel point searching device in the jitter detection mode executing the steps of: obtaining and using each pixel point from the current image based on the Spiral of Archimedes as each reference pixel point and the coordinate of each reference pixel point in the current image as a corresponding reference coordinate, using the pixel point searched in the neighborhood of the reference coordinate of a subsequent image and having a pixel value equal to the pixel value of reference pixel point as the reference pixel point corresponding to the target pixel point and using the coordinate of the subsequent image of the target pixel point as corresponding target coordinate; an image data analysis device, coupled to the pixel point searching device, for obtaining a plurality of reference pixel points and a plurality of reference pixel points respectively corresponding to the plurality of target pixel points, determining a horizontal displacement from each reference coordinate to a corresponding target coordinate thereof, calculating an average of each horizontal displacement of each reference coordinate to obtain a horizontal image displacement, determining a vertical displacement from each reference coordinate to a corresponding target coordinate thereof, calculating an average of each vertical displacement of each reference coordinate to obtain a vertical image displacement, determining an amount of time shift based on the current image timestamp and the subsequent timestamp, and calculating a direction vector of the dot-matrix imaging mechanism based on the amount of time shift, the horizontal image displacement, and the vertical image displacement; an on-site display device, installed onto a side of the dot-matrix imaging mechanism, and coupled to the image data analysis device, for receiving and displaying the direction vector of the dot-matrix imaging mechanism at site; an edge enhancement device, coupled to the dot-matrix imaging mechanism, for receiving an electric heater surrounding image of the current moment, executing an edge enhancement processing of the electric heater surrounding image to obtain a corresponding edge-enhanced image, and outputting the edge-enhanced image; a self-adjusting device, coupled to the edge enhancement device, for receiving the edge-enhanced image, executing a self-adjusting filter processing of the edge-enhanced image based on a noise distribution of the edge-enhanced image to obtain and output a self-adjusting filtered image; a first parameter analysis device, coupled to the self-adjusting device, for receiving the self-adjusting filtered image, determining a content uniformity of the self-adjusting filtered image based on the pixel value distribution of the pixel points of the self-adjusting filtered image, and outputting content uniformity; a second parameter analysis device, for receiving the self-adjusting filtered image, determining a content clarity of the self-adjusting filtered image based on the pixel value dynamic distribution range of the pixel points of the self-adjusting filtered image, and outputting the content clarity; a third parameter analysis device, for receiving the self-adjusting filtered image, detecting a contrast of the self-adjusting filtered image, and outputting the contrast; an area extraction device, coupled to the first parameter analysis device, the second parameter analysis device and the third parameter analysis device, for receiving the content uniformity, the content clarity and the contrast, determining an influence coefficient of an image segmentation threshold based on the content uniformity, determining an influence coefficient of the image segmentation threshold based on the content clarity, determining an influence coefficient of the image segmentation threshold based on the contrast, while correcting the image segmentation threshold based on the three types of influence coefficients, and segmenting the self-adjusting filtered image based on the corrected image segmentation threshold to obtain and output an area to be identified which is out of background; a distribution identification device, coupled to the area extraction device, for receiving the area to be identified, performing an edge point identification of the area to be identified to obtain each edge point in the area to be identified, performing an area segmentation of the area to be identified to obtain each area to be processed, and determining the number of edge points in each area to be processed; an intelligent enhancement device, coupled to the distribution identification device, for receiving the number of edge points of each area to be processed, and setting the area to be processed having a number of edge points exceeding a predetermined quantity threshold as an area to be enhanced, and setting the area to be processed having a number of edge points not exceeding the predetermined quantity threshold as another area; a targeted enhancement device, coupled to the distribution identification device and the intelligent enhancement device, for executing a contrast enhancement of the area to be enhanced based on the corresponding range of the quantity of internal edge points to obtain an enhanced area, and executing the contrast enhancement of the other area of the same range to obtain another processed area; an image fitting device, coupled to the targeted enhancement device, for performing a fitting processing of each enhanced area and each other processed area to obtain a corresponding fitted image, and outputting the fitted image; an image positioning device, installed in the electric heater, and coupled to the image fitting device, for receiving the fitted image, identifying a flame target of the fitted image based on a predetermined standard flame shape, determining positioning data of the flame target based on the position of the flame target in the fitted image, and determining the size of the flame target in an area percentage of the fitted image based on the flame target; and an automatic fire extinguishing device, installed in the electric heater, and coupled to the image positioning device, for receiving the positioning data of the flame target and the size of the flame target, and executing an automatic fire extinguishing operation of the electric heater surrounding flame based on the positioning data of the flame target and the size of the flame target.

In the electric heater fire extinguishing strategy customization mechanism, the real-time display device is provided for a real-time display and a blue string corresponding to the current operation time.

In the electric heater fire extinguishing strategy customization mechanism, the automatic fire extinguishing device implementing an automatic fire extinguishing operation of an electric heater surrounding flame based on the positioning data of the flame target the size of the flame target includes determining a spraying position of the automatic fire extinguishing operation based on the positioning data of the flame target.

In the electric heater fire extinguishing strategy customization mechanism, the automatic fire extinguishing device implementing an automatic fire extinguishing operation of an electric heater surrounding flame based on the positioning data of the flame target the size of the flame target includes determining a spraying strength of the automatic fire extinguishing operation based on the positioning data of the flame target.

In the electric heater fire extinguishing strategy customization mechanism, each area to be enhanced is executed with a contrast enhancement to a range greater than the same range.

In the electric heater fire extinguishing strategy customization mechanism, the self-adjusting device executing a self-adjusting filter processing of the edge-enhanced image based on the noise distribution in the edge-enhanced image includes detecting the dense noise distribution area in the edge-enhanced image and performing a filter processing for the dense noise distribution area only.

In the electric heater fire extinguishing strategy customization mechanism, the pixel point searching device obtains and uses each pixel point obtained from the current image based on the Spiral of Archimedes as a reference pixel point, and each reference pixel point is defined as each pixel point on the Spiral of Archimedes drawn by using the pixel point at the lower right corner of the current image as a starting position.

### BRIEF DESCRIPTION OF THE DRAWINGS

FIG. 1 is a schematic view of an electric heater with an electric heater fire extinguishing strategy customization mechanism in accordance with an embodiment of the present invention.

### DESCRIPTION OF THE PREFERRED EMBODIMENTS

The technical characteristics of the present invention will become apparent with the detailed description of preferred embodiments accompanied with the illustration of related drawings. It is intended that the embodiments and drawings disclosed herein are to be considered illustrative rather than restrictive.

The electric heater becomes popular for the following advantages. Since electricity is a clean energy source, therefore a convectional electric heater has the emission-free, pollution-free and noise-free features, an outstanding environmental protection, and a convenient use with quick heating and immediate stop for power disconnection. Even in the cold areas with a high heating requirement, the electric heater can provide a warming effect. Some of the intelligent models of the electric heaters have the function of setting time and temperature, and they can be move freely in each room for temperature regulation. The electric heater has an excellent power saving effect and can convert more than 99% of electric power into heat, and provide a heat utilization rate up to 100%, and maximize the energy saving effect. In addition, the electric heater has relatively low purchase price and transportation cost. The charge can be calculated according to the use of heater, and there will be no difficulty on charging central heating.

To overcome the aforementioned deficiencies, the present invention discloses an electric heater fire extinguishing strategy customization mechanism to overcome aforementioned technical problems.

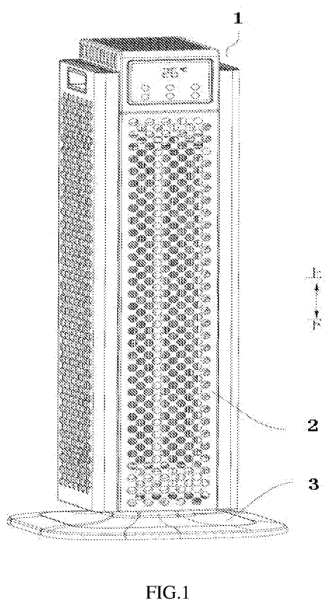

With reference to FIG. 1 for a schematic view of an electric heater with an electric heater fire extinguishing strategy customization mechanism in accordance with an embodiment of the present invention, the numeral 1 stands for a parameter display screen, the numeral 2 stands for a heat dissipating hole, and the numeral 3 stands for a base.

The electric heater fire extinguishing strategy customization mechanism of this embodiment of the invention comprises a timing device, installed onto an integrated circuit board of the electric heater, for counting and using the elapsed time of the electric heater as a current operation time, and outputting the current operation time; and a real-time display device, installed onto the integrated circuit board of the electric heater, and coupled to the timing device, for receiving the current operation time, and being used for a real-time display and a red string corresponding to a too-long operation when the current operation time exceeds a limit.

The specific structure of the electric heater fire extinguishing strategy customization mechanism is further described further below.

The electric heater fire extinguishing strategy customization mechanism further comprises a position sensing device installed on the dot-matrix imaging mechanism for detecting the current position of the dot-matrix imaging mechanism, and determining the difference between the current position and a predetermined fixed position, wherein the difference includes a horizontal change and a vertical change, and if the horizontal change changes between positive and negative values or the vertical change changes between positive and negative values, then a jitter sensing signal will be sent, or else a non-jitter sensing signal will be sent; and a dot-matrix imaging mechanism for photographing the surrounding of the electric heater and continuously outputting a plurality of electric heater surrounding images by a predetermined frame rate.

The electric heater fire extinguishing strategy customization mechanism further comprises an image data extraction device coupled to the dot-matrix imaging mechanism for receiving and using two images sequentially obtained by the dot-matrix imaging mechanism as a current image and a subsequent image respectively, and obtaining a pixel value of each pixel point of the current image and a pixel value of each pixel point of the subsequent image.

The electric heater fire extinguishing strategy customization mechanism further comprises:

a pixel point searching device coupled to the image data extraction device and the position sensing device for entering into a jitter detection mode when the jitter sensing signal is received, and exiting the jitter detection mode when the non-jitter sensing signal is received; the pixel point searching device in the jitter detection mode executing the steps of: obtaining and using each pixel point from the current image based on the Spiral of Archimedes as each reference pixel point and the coordinate of each reference pixel point in the current image as a corresponding reference coordinate, using the pixel point searched in the neighborhood of the reference coordinate of a subsequent image and having a pixel value is equal to the pixel value of reference pixel point as the reference pixel point corresponding to the target pixel point and using the coordinate of the subsequent image of the target pixel point as corresponding target coordinate;

an image data analysis device, coupled to the pixel point searching device, for obtaining a plurality of reference pixel points and a plurality of reference pixel points respectively corresponding to the plurality of target pixel points, determining a horizontal displacement from each reference coordinate to a corresponding target coordinate thereof, calculating an average of each horizontal displacement of each reference coordinate to obtain a horizontal image displacement, determining a vertical displacement from each reference coordinate to a corresponding target coordinate thereof, calculating an average of each vertical displacement of each reference coordinate to obtain a vertical image displacement, determining an amount of time shift based on the current image timestamp and the subsequent timestamp, and calculating a direction vector of the dot-matrix imaging mechanism based on the amount of time shift, the horizontal image displacement, and the vertical image displacement;
an on-site display device, installed onto a side of the dot-matrix imaging mechanism, and coupled to the image data analysis device, for receiving and displaying the direction vector of the dot-matrix imaging mechanism at site;
an edge enhancement device, coupled to the dot-matrix imaging mechanism, for receiving an electric heater surrounding image of the current moment, executing an edge enhancement processing of the electric heater surrounding image to obtain a corresponding edge-enhanced image, and outputting the edge-enhanced image;
a self-adjusting device, coupled to the edge enhancement device, for receiving the edge-enhanced image, executing a self-adjusting filter processing of the edge-enhanced image based on a noise distribution of the edge-enhanced image to obtain and output a self-adjusting filtered image;
a first parameter analysis device, coupled to the self-adjusting device, for receiving the self-adjusting filtered image, determining a content uniformity of the self-adjusting filtered image based on the pixel value distribution of the pixel points of the self-adjusting filtered image, and outputting content uniformity;
a second parameter analysis device, for receiving the self-adjusting filtered image, determining a content clarity of the self-adjusting filtered image based on the pixel value dynamic distribution range of the pixel points of the self-adjusting filtered image, and outputting the content clarity;
a third parameter analysis device, for receiving the self-adjusting filtered image, detecting a contrast of the self-adjusting filtered image, and outputting the contrast;
an area extraction device, coupled to the first parameter analysis device, the second parameter analysis device and the third parameter analysis device, for receiving the content uniformity, the content clarity and the contrast, determining an influence coefficient of an image segmentation threshold based on the content uniformity, determining an influence coefficient of the image segmentation threshold based on the content clarity, determining an influence coefficient of the image segmentation threshold based on the contrast, while correcting the image segmentation threshold based on the three types of influence coefficients, and segmenting the self-adjusting filtered image based on the corrected image segmentation threshold to obtain and output an area to be identified which is out of background;
a distribution identification device, coupled to the area extraction device, for receiving the area to be identified, performing an edge point identification of the area to be identified to obtain each edge point in the area to be identified, performing an area segmentation of the area to be identified to obtain each area to be processed, and determining the number of edge points in each area to be processed;
an intelligent enhancement device, coupled to the distribution identification device, for receiving the number of edge points of each area to be processed, and setting the area to be processed having a number of edge points exceeding a predetermined quantity threshold as an area to be enhanced, and setting the area to be processed having a number of edge points not exceeding the predetermined quantity threshold as another area;
a targeted enhancement device, coupled to the distribution identification device and the intelligent enhancement device, for executing a contrast enhancement of the area to be enhanced based on the corresponding range of the quantity of internal edge points to obtain an enhanced area, and executing the contrast enhancement of the other area of the same range to obtain another processed area;
an image fitting device, coupled to the targeted enhancement device, for performing a fitting processing of each enhanced area and each other processed area to obtain a corresponding fitted image, and outputting the fitted image;
an image positioning device, installed in the electric heater, and coupled to the image fitting device, for receiving the fitted image, identifying a flame target of the fitted image based on a predetermined standard flame shape, determining positioning data of the flame target based on the position of the flame target in the fitted image, and determining the size of the flame target in an area percentage of the fitted image based on the flame target;
an automatic fire extinguishing device, installed in the electric heater, and coupled to the image positioning device, for receiving the positioning data of the flame target and the size of the flame target, and executing an automatic fire extinguishing operation of the electric heater surrounding flame based on the positioning data of the flame target and the size of the flame target.

A pixel point searching device coupled to the image data extraction device and the position sensing device for entering into a jitter detection mode when the jitter sensing signal is received, and exiting the jitter detection mode when the non-jitter sensing signal is received; the pixel point searching device in the jitter detection mode executing the steps of: obtaining and using each pixel point from the current image based on the Spiral of Archimedes as each reference pixel point and the coordinate of each reference pixel point in the current image as a corresponding reference coordinate, using the pixel point searched in the neighborhood of the reference coordinate of a subsequent image and having a pixel value is equal to the pixel value of reference pixel point as the reference pixel point corresponding to the target pixel point and using the coordinate of the subsequent image of the target pixel point as corresponding target coordinate;

an image data analysis device, coupled to the pixel point searching device, for obtaining a plurality of reference pixel points and a plurality of reference pixel points respectively corresponding to the plurality of target pixel points, determining a horizontal displacement from each reference coordinate to a corresponding target coordinate thereof, calculating an average of each horizontal displacement of each reference coordinate to obtain a horizontal image displacement, determining a vertical displacement from each reference coordinate to a corresponding target coordinate thereof, calculating an average of each vertical displacement of each reference coordinate to obtain a vertical image displacement, determining an amount of time shift based on the current image timestamp and the subsequent timestamp, and calculating a direction vector of the dot-matrix imaging mechanism based on the amount of time shift, the horizontal image displacement, and the vertical image displacement;
an on-site display device, installed onto a side of the dot-matrix imaging mechanism, and coupled to the image data analysis device, for receiving and displaying the direction vector of the dot-matrix imaging mechanism at site;
an edge enhancement device, coupled to the dot-matrix imaging mechanism, for receiving an electric heater surrounding image of the current moment, executing an edge enhancement processing of the electric heater surrounding image to obtain a corresponding edge-enhanced image, and outputting the edge-enhanced image;
a self-adjusting device, coupled to the edge enhancement device, for receiving the edge-enhanced image, executing a self-adjusting filter processing of the edge-enhanced image based on a noise distribution of the edge-enhanced image to obtain and output a self-adjusting filtered image;
a first parameter analysis device, coupled to the self-adjusting device, for receiving the self-adjusting filtered image, determining a content uniformity of the self-adjusting filtered image based on the pixel value distribution of the pixel points of the self-adjusting filtered image, and outputting content uniformity;
a second parameter analysis device, for receiving the self-adjusting filtered image, determining a content clarity of the self-adjusting filtered image based on the pixel value dynamic distribution range of the pixel points of the self-adjusting filtered image, and outputting the content clarity;
a third parameter analysis device, for receiving the self-adjusting filtered image, detecting a contrast of the self-adjusting filtered image, and outputting the contrast;
an area extraction device, coupled to the first parameter analysis device, the second parameter analysis device and the third parameter analysis device, for receiving the content uniformity, the content clarity and the contrast, determining an influence coefficient of an image segmentation threshold based on the content uniformity, determining an influence coefficient of the image segmentation threshold based on the content clarity, determining an influence coefficient of the image segmentation threshold based on the contrast, while correcting the image segmentation threshold based on the three types of influence coefficients, and segmenting the self-adjusting filtered image based on the corrected image segmentation threshold to obtain and output an area to be identified which is out of background;
a distribution identification device, coupled to the area extraction device, for receiving the area to be identified, performing an edge point identification of the area to be identified to obtain each edge point in the area to be identified, performing an area segmentation of the area to be identified to obtain each area to be processed, and determining the number of edge points in each area to be processed;
an intelligent enhancement device, coupled to the distribution identification device, for receiving the number of edge points of each area to be processed, and setting the area to be processed having a number of edge points exceeding a predetermined quantity threshold as an area to be enhanced, and setting the area to be processed having a number of edge points not exceeding the predetermined quantity threshold as another area;
a targeted enhancement device, coupled to the distribution identification device and the intelligent enhancement device, for executing a contrast enhancement of the area to be enhanced based on the corresponding range of the quantity of internal edge points to obtain an enhanced area, and executing the contrast enhancement of the other area of the same range to obtain another processed area;
an image fitting device, coupled to the targeted enhancement device, for performing a fitting processing of each enhanced area and each other processed area to obtain a corresponding fitted image, and outputting the fitted image;
an image positioning device, installed in the electric heater, and coupled to the image fitting device, for receiving the fitted image, identifying a flame target of the fitted image based on a predetermined standard flame shape, determining positioning data of the flame target based on the position of the flame target in the fitted image, and determining the size of the flame target in an area percentage of the fitted image based on the flame target;
an automatic fire extinguishing device, installed in the electric heater, and coupled to the image positioning device, for receiving the positioning data of the flame target and the size of the flame target, and executing an automatic fire extinguishing operation of the electric heater surrounding flame based on the positioning data of the flame target and the size of the flame target.

In the electric heater fire extinguishing strategy customization mechanism, the real-time display device is provided for a real-time display and a blue string corresponding to the current operation time.

In the electric heater fire extinguishing strategy customization mechanism, the automatic fire extinguishing device implementing an automatic fire extinguishing operation of an electric heater surrounding flame based on the positioning data of the flame target the size of the flame target includes determining a spraying position of the automatic fire extinguishing operation based on the positioning data of the flame target.

In the electric heater fire extinguishing strategy customization mechanism, the automatic fire extinguishing device implementing an automatic fire extinguishing operation of an electric heater surrounding flame based on the positioning data of the flame target the size of the flame target includes determining a spraying strength of the automatic fire extinguishing operation based on the positioning data of the flame target.

In the electric heater fire extinguishing strategy customization mechanism, each area to be enhanced is executed with a contrast enhancement to a range greater than the same range.

In the electric heater fire extinguishing strategy customization mechanism, the self-adjusting device executing a self-adjusting filter processing of the edge-enhanced image based on the noise distribution in the edge-enhanced image includes detecting the dense noise distribution area in the edge-enhanced image and performing a filter processing for the dense noise distribution area only.

In the electric heater fire extinguishing strategy customization mechanism, the pixel point searching device obtains and uses each pixel point obtained from the current image based on the Spiral of Archimedes as a reference pixel point, and each reference pixel point is defined as each pixel point on the Spiral of Archimedes drawn by using the pixel point at the lower right corner of the current image as a starting position.

In addition, the electric heater fire extinguishing strategy customization mechanism can use a (Generic Array Logic) GAL device as the image positioning device (Please refer to the website www.husoon.com). The GAL device was first developed by LATTICE Company in 1985, and this device has an electrically erasable and programmable design and can be set with encryption bits, and representative GAL chips include GAL16V8 and GAL20 which can emulate almost all types of PAL devices. In practical applications, the GAL device has 100% compatibility on the emulation of the PAL device, so that the GAL device can almost substitute all PAL devices and a vast majority of SSI and MSI digital integrated circuits and thus the GAL device becomes very popular.

The major difference between GAL and PAL resides on that the output structure of the GAL is user-defined, and thus it is a programmable output structure. The aforementioned two basic models of GAL including the GAL16V8 (20-pin) and the GAL20V8 (24-pin) can substitute tens of PAL devices, so that it is called a general programmable circuit. On the other hand, the output of the PAL is defined by manufacturers, and thus the output cannot be changed by users once the chip is defined and fixed.

Compared with the conventional electric heater without an automatic fire extinguishing function, the electric heater fire extinguishing strategy customization mechanism of the present invention can be installed on the electric heater and provided for determining the spraying position and the spraying strength of the automatic fire extinguishing operation based on the positioning data of the flame target, wherein the position sensing device is provided for determining the jitter condition of the dot-matrix imaging mechanism, and then accurately determining the direction and amount of jitter of the dot-matrix imaging mechanism based on the pixel value search results of the previous and next images after the jitter is determined, enhancing the contrast of images in different areas for the distribution of edge points in the images to facilitate various subsequent image processes; performing a self-adjusting filter processing of the filter processing of the edge-enhanced images for the dense noise distribution area only to achieve a balance between the filtering effect and the filtering computation, while obtaining an area to be identified effectively from a customized background segmentation mode, so as to overcome the aforementioned technical problems.

While the invention has been described by means of specific embodiments, numerous modifications and variations could be made thereto by those skilled in the art without departing from the scope and spirit of the invention as set forth in the claims.

1-10. (canceled)

11. An electric heater fire extinguishing strategy customization mechanism, comprising:
a timing device, installed onto an integrated circuit board of the electric heater, for counting and using the elapsed time of the electric heater as a current operation time, and outputting the current operation time; and
a real-time display device, installed onto the integrated circuit board of the electric heater, and coupled to the timing device, for receiving the current operation time, and being used for a real-time display and a red string corresponding to a too-long operation when the current operation time exceeds a limit.
further comprising: a position sensing device installed on the dot-matrix imaging mechanism for detecting the current position of the dot-matrix imaging mechanism, and determining the difference between the current position and a predetermined fixed position, wherein the difference includes a horizontal change and a vertical change, and if the horizontal change changes between positive and negative values or the vertical change changes between positive and negative values, then a jitter sensing signal will be sent, or else a non-jitter sensing signal will be sent; and a dot-matrix imaging mechanism for photographing the surrounding of the electric heater and continuously outputting a plurality of electric heater surrounding images by a predetermined frame rate.
further comprising an image data extraction device coupled to the dot-matrix imaging mechanism for receiving and using two images sequentially obtained by the dot-matrix imaging mechanism as a current image and a subsequent image respectively, and obtaining a pixel value of each pixel point of the current image and a pixel value of each pixel point of the subsequent image.
further comprising a pixel point searching device coupled to the image data extraction device and the position sensing device for entering into a jitter detection mode when the jitter sensing signal is received, and exiting the jitter detection mode when the non-jitter sensing signal is received; the pixel point searching device in the jitter detection mode executing the steps of: obtaining and using each pixel point from the current image based on the Spiral of Archimedes as each reference pixel point and the coordinate of each reference pixel point in the current image as a corresponding reference coordinate, using the pixel point searched in the neighborhood of the reference coordinate of a subsequent image and having a pixel value equal to the pixel value of reference pixel point as the reference pixel point corresponding to the target pixel point and using the coordinate of the subsequent image of the target pixel point as corresponding target coordinate;
an image data analysis device, coupled to the pixel point searching device, for obtaining a plurality of reference pixel points and a plurality of reference pixel points respectively corresponding to the plurality of target pixel points, determining a horizontal displacement from each reference coordinate to a corresponding target coordinate thereof, calculating an average of each horizontal displacement of each reference coordinate to obtain a horizontal image displacement, determining a vertical displacement from each reference coordinate to a corresponding target coordinate thereof, calculating an average of each vertical displacement of each reference coordinate to obtain a vertical image displacement, determining an amount of time shift based on the current image timestamp and the subsequent timestamp, and calculating a direction vector of the dot-matrix imaging mechanism based on the amount of time shift, the horizontal image displacement, and the vertical image displacement;
an on-site display device, installed onto a side of the dot-matrix imaging mechanism, and coupled to the image data analysis device, for receiving and displaying the direction vector of the dot-matrix imaging mechanism at site;
an edge enhancement device, coupled to the dot-matrix imaging mechanism, for receiving an electric heater surrounding image of the current moment, executing an edge enhancement processing of the electric heater surrounding image to obtain a corresponding edge-enhanced image, and outputting the edge-enhanced image;
a self-adjusting device, coupled to the edge enhancement device, for receiving the edge-enhanced image, executing a self-adjusting filter processing of the edge-enhanced image based on a noise distribution of the edge-enhanced image to obtain and output a self-adjusting filtered image;
a first parameter analysis device, coupled to the self-adjusting device, for receiving the self-adjusting filtered image, determining a content uniformity of the self-adjusting filtered image based on the pixel value distribution of the pixel points of the self-adjusting filtered image, and outputting content uniformity;
a second parameter analysis device, for receiving the self-adjusting filtered image, determining a content clarity of the self-adjusting filtered image based on the pixel value dynamic distribution range of the pixel points of the self-adjusting filtered image, and outputting the content clarity;
a third parameter analysis device, for receiving the self-adjusting filtered image, detecting a contrast of the self-adjusting filtered image, and outputting the contrast;
an area extraction device, coupled to the first parameter analysis device, the second parameter analysis device and the third parameter analysis device, for receiving the content uniformity, the content clarity and the contrast, determining an influence coefficient of an image segmentation threshold based on the content uniformity, determining an influence coefficient of the image segmentation threshold based on the content clarity, determining an influence coefficient of the image segmentation threshold based on the contrast, while correcting the image segmentation threshold based on the three types of influence coefficients, and segmenting the self-adjusting filtered image based on the corrected image segmentation threshold to obtain and output an area to be identified which is out of background;
a distribution identification device, coupled to the area extraction device, for receiving the area to be identified, performing an edge point identification of the area to be identified to obtain each edge point in the area to be identified, performing an area segmentation of the area to be identified to obtain each area to be processed, and determining the number of edge points in each area to be processed;
an intelligent enhancement device, coupled to the distribution identification device, for receiving the number of edge points of each area to be processed, and setting the area to be processed having a number of edge points exceeding a predetermined quantity threshold as an area to be enhanced, and setting the area to be processed having a number of edge points not exceeding the predetermined quantity threshold as another area;
a targeted enhancement device, coupled to the distribution identification device and the intelligent enhancement device, for executing a contrast enhancement of the area to be enhanced based on the corresponding range of the quantity of internal edge points to obtain an enhanced area, and executing the contrast enhancement of the other area of the same range to obtain another processed area;
an image fitting device, coupled to the targeted enhancement device, for performing a fitting processing of each enhanced area and each other processed area to obtain a corresponding fitted image, and outputting the fitted image;
an image positioning device, installed in the electric heater, and coupled to the image fitting device, for receiving the fitted image, identifying a flame target of the fitted image based on a predetermined standard flame shape, determining positioning data of the flame target based on the position of the flame target in the fitted image, and determining the size of the flame target in an area percentage of the fitted image based on the flame target; and
an automatic fire extinguishing device, installed in the electric heater, and coupled to the image positioning device, for receiving the positioning data of the flame target and the size of the flame target, and executing an automatic fire extinguishing operation of the electric heater surrounding flame based on the positioning data of the flame target and the size of the flame target.

12. The electric heater fire extinguishing strategy customization mechanism as claimed in claim 11, wherein the real-time display device is provided for a real-time display and a blue string corresponding to the current operation time.

13. The electric heater fire extinguishing strategy customization mechanism as claimed in claim 12, wherein the automatic fire extinguishing device implementing an automatic fire extinguishing operation of an electric heater surrounding flame based on the positioning data of the flame target the size of the flame target includes determining a spraying position of the automatic fire extinguishing operation based on the positioning data of the flame target.

14. The electric heater fire extinguishing strategy customization mechanism as claimed in claim 13, wherein the automatic fire extinguishing device implementing an automatic fire extinguishing operation of an electric heater surrounding flame based on the positioning data of the flame target the size of the flame target includes determining a spraying strength of the automatic fire extinguishing operation based on the positioning data of the flame target.

15. The electric heater fire extinguishing strategy customization mechanism as claimed in claim 14, wherein each area to be enhanced is executed with a contrast enhancement to a range greater than the same range.

16. The electric heater fire extinguishing strategy customization mechanism as claimed in claim 15, wherein the self-adjusting device executing a self-adjusting filter processing of the edge-enhanced image based on the noise distribution in the edge-enhanced image includes detecting the dense noise distribution area in the edge-enhanced image and performing a filter processing for the dense noise distribution area only.

17. The electric heater fire extinguishing strategy customization mechanism as claimed in claim 16, wherein the pixel point searching device obtains and uses each pixel point obtained from the current image based on the Spiral of Archimedes as a reference pixel point, and each reference pixel point is defined as each pixel point on the Spiral of Archimedes drawn by using the pixel point at the lower right corner of the current image as a starting position.
